(19) United States
(12) Patent Application Publication
(10) Pub. No.: US 2013/0099980 A1
(43) Pub. Date: Apr. 25, 2013

(54) ANTENNA DEVICE AND ELECTRONIC APPARATUS INCLUDING ANTENNA DEVICE

(71) Applicant: Kouji Hayashi, Akishima-shi (JP)

(72) Inventor: Kouji Hayashi, Akishima-shi (JP)

(21) Appl. No.: 13/564,507

(22) Filed: Aug. 1, 2012

(30) Foreign Application Priority Data
Oct. 19, 2011 (JP) 2011-230009

(51) Int. Cl. H01Q 9/04

(52) U.S. Cl. 343/700 MS

(57) ABSTRACT

According to one embodiment, an antenna device according to this embodiment includes an antenna ground portion and first and second antenna units. The first antenna unit includes a first feed point, a first feed element connected to the first feed point, and a first parasitic element which operates upon electrically coupling to the first feed element. The second antenna unit includes a second feed point, a second feed element connected to the second feed point, and a second parasitic element which operates upon electrically coupling to the first parasitic element and the second feed element.

### CROSS-REFERENCE TO RELATED APPLICATIONS

This application is based upon and claims the benefit of priority from prior Japanese Patent Application No. 2011-230009, filed Oct. 19, 2011, the entire contents of which are incorporated herein by reference.

### FIELD

Embodiments described herein relate generally to an antenna device and an electronic apparatus including the antenna device.

### BACKGROUND

Various kinds of electronic apparatuses have been developed, which make personal computers and television receivers incorporate radio interfaces using a wireless local area network (LAN), WiMAX®, ultra-wideband (UWB), Bluetooth®, and the like to download content and various kinds of data from Web sites and the like via radio interfaces.

The antenna device used in the above radio interface generally includes two antennas to obtain a diversity effect. For this reason, when an electronic apparatus is to accommodate an antenna device, the apparatus needs to ensure a wider accommodation space than when using one antenna. On the other hand, an electronic apparatus such as a personal computer has a limited surplus space in the low-profile housing and high-density packing of circuit components. For this reason, when accommodating an antenna device in an electronic apparatus, the two antennas are inevitably located close to each other. If, however, the two antennas are close to each other, the interference between the antennas becomes large. This may fail to obtain desired antenna performance.

Under the circumstances, there has been proposed an antenna device designed to cancel a current flowing between feed portions by using an open stub. There has also been proposed an antenna device designed to place a loop type parasitic element between antenna elements and reduce the spatial coupling between the antenna elements by using the loop type parasitic element.

The antenna device designed to cancel a current flowing between the feed portions by using the open stub needs to provide a notch in a ground plate. This makes it difficult to implement such a structure because of the need of precision work for an electronic apparatus reduced in size. Even if such a structure can be implemented, a short may occur at the notch via a feed cable or the like.

In addition, the antenna device designed to reduce the spatial coupling between the antenna elements by using the loop type parasitic element reduces the spatial coupling between the antenna elements, and hence does not reduce a current flowing between feed points via a ground plate. That is, in this device, the isolation effect between the antenna elements is low.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing the arrangement of the main part of an electronic apparatus including an antenna device according to the first embodiment;

FIG. 2 is a view showing an example of the arrangement of the antenna device shown in FIG. 1;

FIG. 3 is a perspective view showing the arrangement of the main part of an electronic apparatus including an antenna device according to the second embodiment;

FIG. 4 is a perspective view showing the arrangement of the main part of an electronic apparatus including an antenna device according to the third embodiment;

FIG. 5 is a perspective view showing the arrangement of the main part of an electronic apparatus including an antenna device according to the fourth embodiment;

FIG. 6 is a perspective view showing the arrangement of the main part of an electronic apparatus including an antenna device according to the fifth embodiment;

FIG. 7 is a perspective view showing the arrangement of the main part of an electronic apparatus including an antenna device according to the sixth embodiment;

FIG. 8 is a perspective view showing the arrangement of the main part of an electronic apparatus including an antenna device according to the seventh embodiment;

FIG. 9 is a perspective view showing the arrangement of the main part of an electronic apparatus including an antenna device according to the eighth embodiment;

FIG. 10 is a perspective view showing the arrangement of the main part of an electronic apparatus including an antenna device according to the ninth embodiment;

FIG. 11 is a graph showing the frequency characteristics of S-parameters in the antenna device shown in FIG. 10;

FIG. 12 is a perspective view showing the arrangement of an electronic apparatus including a conventional antenna device; and

FIG. 13 is a graph showing the frequency characteristics of S-parameters in the antenna device shown in FIG. 12.

### DETAILED DESCRIPTION

Various embodiments will be described hereinafter with reference to the accompanying drawings.

In general, according to one embodiment, an antenna device includes an antenna ground portion disposed substantially parallel to a ground portion of an electronic apparatus and connected to the ground portion via a ground element, and a first antenna unit and a second antenna unit which are disposed close to each other within a predetermined distance along a side of the antenna ground portion and for which substantially equal frequency bands for transmission or reception are set.

The first antenna unit includes a first feed point disposed close to the side of the antenna ground portion, a first feed element having an intermediate portion bent at least once, one end portion connected to the first feed point, and the other end portion open, and a first parasitic element which has one end portion connected to the antenna ground portion and the other end portion open, and operates upon electrically coupling to the first feed element.

The second antenna unit includes a second feed point disposed away from the first feed point at a position near the side of the antenna ground portion, a second feed element having an intermediate portion bent at least once, one end portion connected to the second feed point, and the other end portion open, and a second parasitic element which has one end portion connected to the antenna ground portion and the other end portion open, operates upon electrically coupling to the second feed element, and also operates upon electrically coupling to the first parasitic element.

According to this embodiment, it is possible to improve the isolation characteristic between the first and second feed elements with the simple arrangement obtained by only arranging the first and second parasitic elements between the first and second feed elements without forming any notch or the like in the antenna ground portion. This allows to obtain a sufficient isolation characteristic even in a compact electronic apparatus such as a portable electronic apparatus in which the first and second antenna units must be located close to each other. That is, this arrangement is especially effective for such an apparatus. In addition, electrically coupling the first and second parasitic elements to the first and second feed elements, respectively, can extend the resonance band of the first and second feed elements.

### First Embodiment

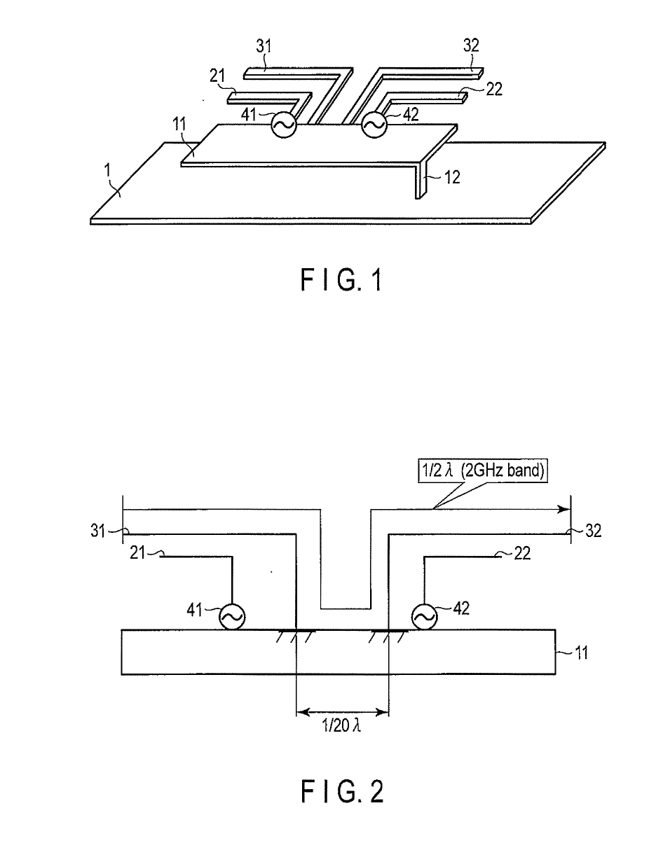

FIG. 1 is a perspective view showing the arrangement of the main part of an electronic apparatus including an antenna device according to the first embodiment.

This electronic apparatus is formed from a notebook personal computer or television receiver including a radio interface, and includes a ground plate 1 accommodated in the housing (not shown). The ground plate 1 is the one using part of a metal housing or a metal member such as a copper foil, or is formed from a printed circuit board or multilayer board on which a metal ground pattern is formed.

Note that the electronic apparatus may be a portable terminal such as a navigation terminal, cellular phone, smartphone, personal digital assistant (PDA), or tablet-type terminal instead of a notebook computer or television receiver.

The antenna device is mounted on the ground plate 1. The antenna device includes a ground plate 11 and first and second antenna units arranged along one side of the ground plate 11. The ground plate 11 is formed from, for example, a printed circuit board on which a ground pattern is formed. One corner portion of the ground plate 11 is connected to the ground surface of the ground plate 1 of the electronic apparatus via a ground element 12 while the ground plate 11 is parallel to the surface of the ground plate 1.

The first and second antenna units are spaced apart from each other while covering the same frequency band to obtain a diversity effect. The first and second antenna units respectively include feed points 41 and 42 arranged along a side of the ground plate 11, feed elements (to be referred to as antenna elements hereinafter) 21 and 22 operating as antenna elements, and parasitic elements 31 and 32.

The feed points 41 and 42 are connected to a radio unit (not shown) mounted on the ground plate 11 via feed cables (not shown) or feed patterns. The antenna elements 21 and 22 are formed from L-shaped monopole elements having proximal end portions respectively connected to the feed points 41 and 42, and the distal end portions open, and are disposed such that their horizontal portions face the opposite directions.

The parasitic elements 31 and 32 are formed from L-shaped elements like the antenna elements 21 and 22 described above. The proximal end portions of the parasitic elements 31 and 32 are connected to the ground plate 11 at positions located between the feed points 41 and 42 and close to them, with the distal end portions being open. As shown in FIG. 2, the interval between the ground positions of the parasitic elements 31 and 32 on the ground plate 11 is set to a finite length 1/20 or less of a wavelength corresponding to the frequency band (e.g., the 2-GHz band) which the antenna device according to the first embodiment covers. The element length of each of the parasitic elements 31 and 32, i.e., the length from the distal end of the parasitic element 31 to the distal end of the parasitic element 32 through the ground plate 11, is set to ½ a wavelength corresponding to the above wavelength band (e.g., the 2-GHz band).

With this arrangement, the parasitic elements 31 and 32 are electrically coupled to the antenna elements 21 and 22, respectively, to operate to extend the resonance bandwidth of the antenna elements 21 and 22. In addition, since the interval between the ground points of the parasitic elements 31 and 32 is set to 1/20 or less of a wavelength corresponding to the transmission/reception frequency band of the antenna elements 21 and 22, the parasitic elements 31 and 32 are electrically coupled to each other. This will reduce the amount of high-frequency current flowing into the feed points 42 and 41 between the feed points 41 and 42. This can therefore reduce the mutual coupling between the antenna elements 21 and 22.

That is, the first embodiment can improve the isolation characteristic between the antenna elements 21 and 22 with the simple arrangement obtained by only arranging the L-shaped parasitic elements 31 and 32 between the antenna elements 21 and 22 without forming any notch or the like in the ground plate. This allows to obtain a sufficient isolation characteristic even in a compact electronic apparatus such as a portable electronic apparatus in which the first and second antenna units must be located close to each other. That is, this arrangement is especially effective for such an apparatus. In addition, electrically coupling the parasitic elements 31 and 32 to the antenna elements 21 and 22, respectively, can extend the resonance band of the antenna elements 21 and 22.

### Second Embodiment

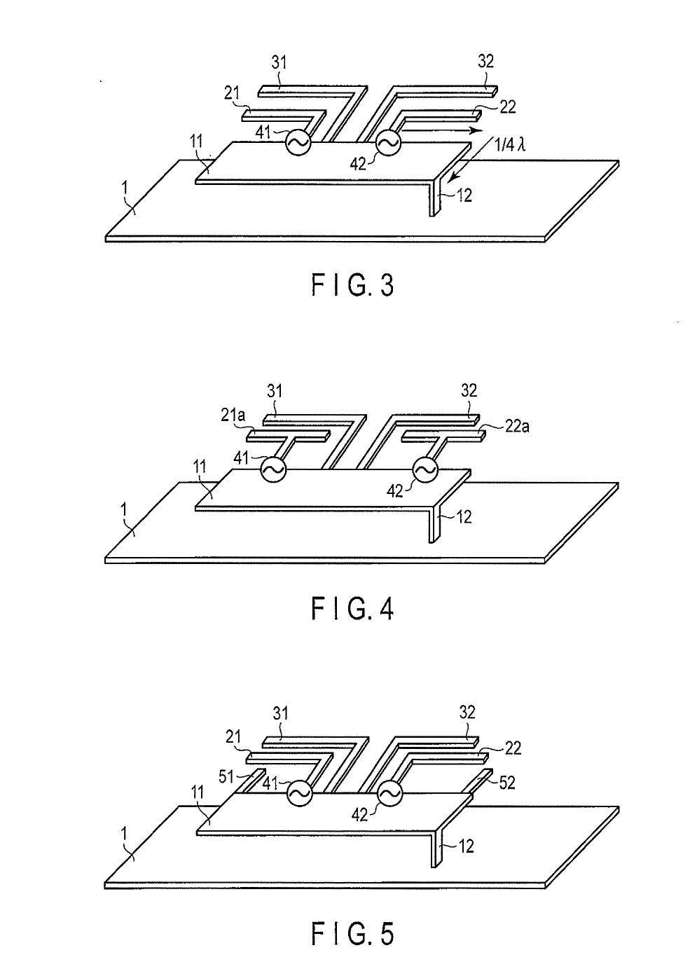

FIG. 3 is a perspective view showing the arrangement of the main part of an electronic apparatus including an antenna device according to the second embodiment. The same reference numbers as in FIG. 2 denote the same parts in FIG. 1, and a detailed description of them will be omitted.

In the antenna device according to the second embodiment, the size of a side of a ground plate 11 or the position of a ground element 12 for connecting the ground plate 11 to a ground plate 1 of the electronic apparatus is set such that the length from a feed point 42 to the ground element 12 along two sides of the ground plate 1 becomes 1/4 a wavelength corresponding to the transmission/reception frequency band of a antenna element 22.

With this arrangement, two sides (edges) of the ground plate 1, which extend from the feed point 42 to the ground element 12, function as antenna elements each having an element length of ¼ the wavelength. It is therefore possible to extend the resonance band of the radio communication antenna 22 by using the two sides (edges) of the ground plate 1 which function as the above antenna elements.

Note that the installation position of the ground element 12 may be set at a corner portion of the ground plate 1 which is located on the first antenna unit side. In this case as well, the length from a feed point 41 to the ground element along the two sides of the ground plate 11 is set to ¼ a wavelength corresponding to the transmission/reception frequency band of the antenna element 21. The number of ground element to be provided is not limited to one, and may be plural.

### Third Embodiment

FIG. 4 is a perspective view showing the arrangement of the main part of an electronic apparatus including an antenna device according to the third embodiment. The same reference numbers as in FIG. 4 denote the same parts in FIG. 1, and a detailed description of them will be omitted.

In the antenna device according to the third embodiment, antenna elements 21a and 22a are formed from T-shaped elements, the lower end portions of the vertical portions of the antennas are connected to feed points 41 and 42, and the horizontal portions of parasitic elements 31 and 32 are electrically coupled to the horizontal portions of the antenna elements 21a and 22a.

With this arrangement as well, as in the first embodiment, coupling the antenna elements 21a and 22a to the parasitic elements 31 and 32 can extend the resonance bandwidth of the antenna elements 21a and 22a. In addition, setting the interval between the ground points of the parasitic elements 31 and 32 to 1/20 or less a wavelength corresponding to the transmission/reception frequency band of the antenna elements 21a and 22a will electrically couple the parasitic element 32 to each other. As a consequence, the amount of high-frequency current flowing into the feed points 42 and 41 between the feed points 41 and 42 decreases. This can reduce the mutual coupling between the antenna elements 21a and 22a.

### Fourth Embodiment

FIG. 5 is a perspective view showing the arrangement of the main part of an electronic apparatus including an antenna device according to the fourth embodiment. The same reference numbers as in FIG. 5 denote the same parts in FIG. 1, and a detailed description of them will be omitted.

In the antenna device according to the fourth embodiment, parasitic elements 51 and 52 are arranged at positions opposite to parasitic elements 31 and 32 through antenna elements 21 and 22. The installation positions of the parasitic elements 51 and 52 are set to electrically couple the parasitic elements 51 and 52 to the antenna elements 21 and 22, respectively.

With this arrangement, the parasitic elements 51 and 52 can further extend the resonance band of the antenna elements 21 and 22.

### Fifth Embodiment

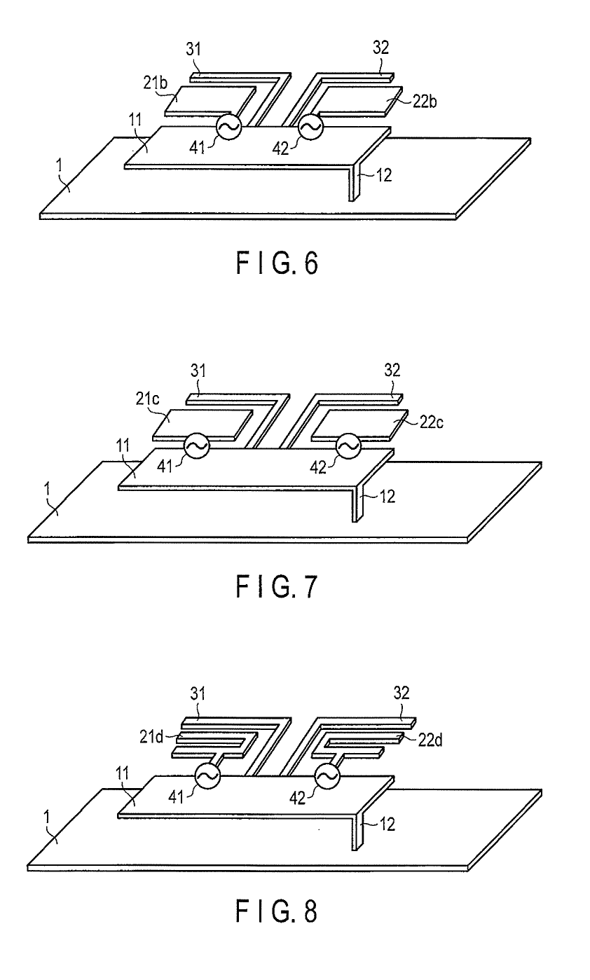

FIG. 6 is a perspective view showing the arrangement of the main part of an electronic apparatus including an antenna device according to the fifth embodiment. The same reference numbers as in FIG. 6 denote the same parts in FIG. 1, and a detailed description of them will be omitted.

In the antenna device according to the fifth embodiment, antenna elements 21b and 22b are formed from planar monopole elements, and one corner portion of each of the antennas is connected to a corresponding one of feed points 41 and 42. One side of each of the antenna elements 21b and 22b in the vertical direction and one side of each of them in the horizontal direction are electrically coupled to the vertical and horizontal portions of a corresponding one of parasitic elements 31 and 32, respectively.

In this arrangement as well, as in the first embodiment, coupling the antenna elements 21b and 22b to the parasitic elements 31 and 32 can extend the resonance bandwidth of the antenna elements 21b and 22b. In addition, since the interval between the ground points of the parasitic elements 31 and 32 is set to 1/20 or less of a wavelength corresponding to the transmission/reception frequency band of the antenna elements 21b and 22b, the parasitic elements 31 and 32 are electrically coupled to each other. This will reduce the amount of high-frequency current flowing into the feed points 41 and 42 between them. This can therefore reduce the mutual coupling between the antenna elements 21b and 22b.

### Sixth Embodiment

FIG. 7 is a perspective view showing the arrangement of the main part of an electronic apparatus including an antenna device according to the sixth embodiment. The same reference numbers as in FIG. 7 denote the same parts in FIG. 1, and a detailed description of them will be omitted.

In the antenna device according to the sixth embodiment, antenna elements 21c and 22c are formed from planar monopole elements, and an intermediate portion of the lower side of each of the antennas is connected to a corresponding one of feed points 41 and 42. One side of each of the antenna elements 21c and 22c in the vertical direction and one side of each of them in the horizontal direction are electrically coupled to the vertical and horizontal portions of a corresponding one of parasitic elements 31 and 32, respectively.

In this arrangement as well, as in the first embodiment, coupling the antenna elements 21c and 22c to the parasitic elements 31 and 32 can extend the resonance bandwidth of the antenna elements 21c and 22c. In addition, since the interval between the ground points of the parasitic elements 31 and 32 is set to 1/20 or less of a wavelength corresponding to the transmission/reception frequency band of the antenna elements 21c and 22c, the parasitic elements 31 and 32 are electrically coupled to each other. This will reduce the amount of high-frequency current flowing into the feed points 41 and 42 between them. This can therefore reduce the mutual coupling between the antenna elements 21c and 22c.

### Seventh Embodiment

FIG. 8 is a perspective view showing the arrangement of the main part of an electronic apparatus including an antenna device according to the seventh embodiment. The same reference numbers as in FIG. 8 denote the same parts in FIG. 4, and a detailed description of them will be omitted.

The antenna device according to the seventh embodiment is a modification of the third embodiment. Radio communication antennas 21d and 22d each are formed into a U-shape, and the intermediate portions of the lower horizontal portions of the antennas are respectively connected to feed points 41 and 42 via vertical pieces. The vertical and horizontal portions of the antenna elements 21d and 22d are electrically coupled to the vertical and horizontal portions of parasitic elements 31 and 32, respectively.

In this arrangement as well, as in the third embodiment, coupling the antenna elements 21d and 22d to the parasitic elements 31 and 32 can extend the resonance bandwidth of the antenna elements 21d and 22d. In addition, since the interval between the ground points of the parasitic elements 31 and 32 is set to 1/20 or less of a wavelength corresponding to the transmission/reception frequency band of the antenna elements 21d and 22d, the parasitic elements 31 and 32 are electrically coupled to each other. This will reduce the amount of high-frequency current flowing into the feed points 41 and 42 between them. This can therefore reduce the mutual coupling between the antenna elements 21d and 22d.

### Eighth Embodiment

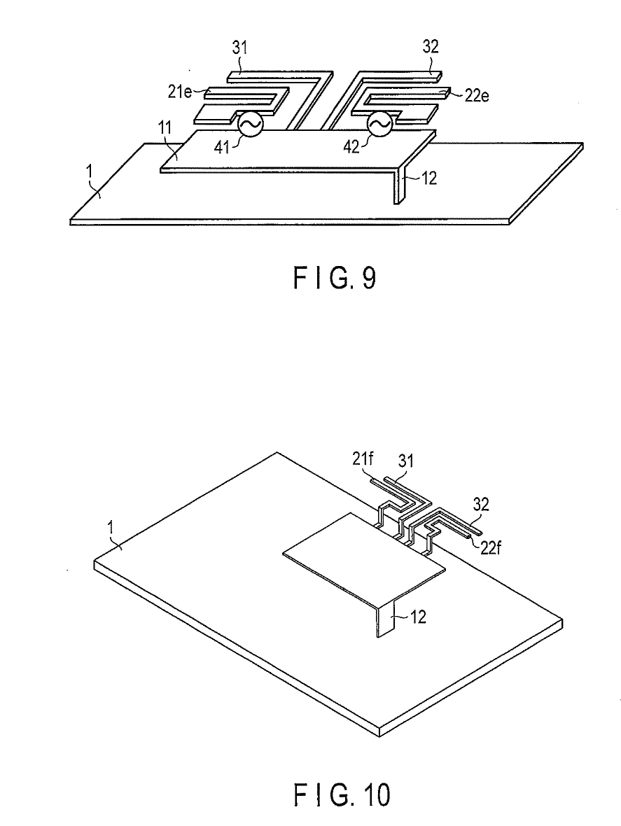

FIG. 9 is a perspective view showing the arrangement of the main part of an electronic apparatus including an antenna device according to the eighth embodiment. The same reference numbers as in FIG. 9 denote the same parts in FIG. 8, and a detailed description of them will be omitted.

The antenna device according to the eight embodiment is a modification of the seventh embodiment. Radio communication antennas 21e and 22e each are formed into a U-shape, and the distal end portions of the lower horizontal portions of the antennas each are formed into a plate shape.

In this arrangement as well, as in the seventh embodiment, coupling the antenna elements 21e and 22e to the parasitic elements 31 and 32 can extend the resonance bandwidth of the antenna elements 21e and 22e. In addition, since the interval between the ground points of the parasitic elements 31 and 32 is set to 1/20 or less of a wavelength corresponding to the transmission/reception frequency band of the antenna elements 21e and 22e, the parasitic elements 31 and 32 are electrically coupled to each other. This will reduce the amount of high-frequency current flowing into the feed points 41 and 42 between them. This can therefore reduce the mutual coupling between the antenna elements 21e and 22e.

### Ninth Embodiment

FIG. 10 is a perspective view showing the arrangement of the main part of an electronic apparatus including an antenna device according to the ninth embodiment. The same reference numbers as in FIG. 10 denote the same parts in FIG. 1, and a detailed description of them will be omitted.

In the antenna device according to the ninth embodiment, antenna elements 21f and 22f each are formed into a U-shape, and one of the horizontal portions of each of the antennas is bent at a right angle within a horizontal plane and further bent downward in the vertical direction, with one end portion of the bent portion being connected to a feed point. In addition, parasitic elements 31 and 32 each are formed into an L-shape, and one end portion of each element is then bent downward in the vertical direction, with its end portion being connected to a ground plate 11. The parasitic elements 31 and 32 are arranged such that the L-shaped portions are electrically coupled to the U-shaped portions of the antenna elements 21f and 22f. In addition, the interval between the ground points of the parasitic elements 31 and 32 is set to 1/20 or less of a wavelength corresponding to the transmission/reception frequency band of the antenna elements 21f and 22f.

With this arrangement, as in the first embodiment, coupling the antenna elements 21f and 22f to the parasitic elements 31 and 32 can extend the resonance bandwidth of the antenna elements 21f and 22f. In addition, since the interval between the ground points of the parasitic elements 31 and 32 is set to 1/20 or less of a wavelength corresponding to the transmission/reception frequency band of the antenna elements 21f and 22f, the parasitic elements 31 and 32 are electrically coupled to each other. This will reduce the amount of high-frequency current flowing into the feed points between them. This can therefore reduce the mutual coupling between the antenna elements 21f and 22f. In addition, the proximal end portions of the antenna elements 21f and 22f and of the parasitic elements 31 and 32 are bent downward in the vertical direction, and the end portions of the bent portions are grounded to the ground plate 11. This makes it possible to locate the open ends of the antenna elements 21f and 22f and of the parasitic elements 31 and 32 away from the ground plate 1. This can reduce the influence of the ground plate 1 on the antenna elements 21f and 22f and the parasitic elements 31 and 32 and improve the antenna radiation performance.

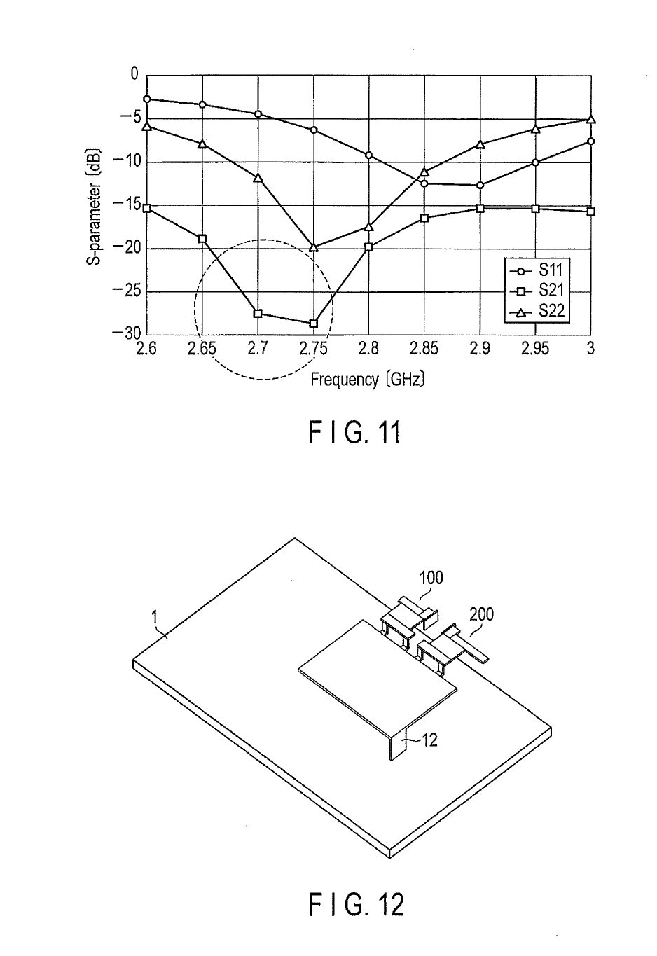

FIG. 11 shows the frequency characteristics of S-parameters in the antenna device according to the ninth embodiment. Referring to FIG. 11, reference symbols S11 and S22 respectively denote the reflection coefficients of the first and second antenna units; and S21, the coupling coefficient of the second antenna unit with respect to the first antenna unit. As is obvious from these characteristics, it is possible to reduce the coupling coefficient between the antenna units in the 2.65 to 2.8 GHz band, which is the main transmission/reception band of the antenna device to −20 dB or less. This makes it possible to ensure high isolation performance between the antenna units.

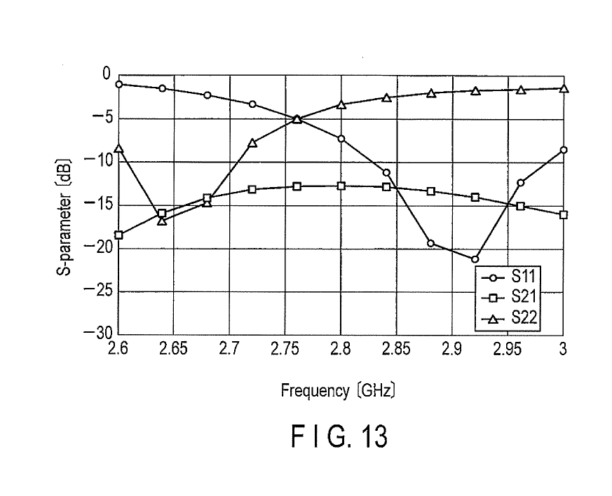

By comparison, according to the conventional antenna device without any parasitic element exemplified in FIG. 12, the coupling coefficient between the first and second antenna units does not decrease to −20 dB or less over the 2 GHz band, as indicated by S21 in FIG. 13. As a consequence, it is not possible to ensure sufficient isolation performance.

### Other Embodiments

Each embodiment described above has exemplified the case in which signals from the radio LAN are received. However, a target system may be the one which receives signals transmitted from other systems such as a terrestrial digital radio broadcasting system and a municipally-managed disaster prevention broadcasting system.

In addition, the above embodiments can be executed by variously modifying the shapes, sizes, and the like of the antenna elements, parasitic elements, and the ground plates of the antenna devices.

Although several embodiments have been described above, they are merely examples and not intended to limit the scope of the present invention. These novel embodiments can be implemented in other various forms, and various omissions, replacements, and changes can be made without departing from the spirit of the present invention. These embodiments and their modifications are included in the scope and spirit of the present invention, and are also included in the scope of the invention and its equivalents defined in the appended claims.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An antenna device comprising:
an antenna ground portion disposed substantially parallel to a ground portion of an electronic apparatus and connected to the ground portion via a ground element; and
a first antenna unit and a second antenna unit which are disposed close to each other within a predetermined distance along a side of the antenna ground portion and for which substantially equal frequency bands for transmission or reception are set,
wherein the first antenna unit comprises
a first feed point disposed close to the side of the antenna ground portion,
a first feed element having an intermediate portion bent at least once, one end portion connected to the first feed point, and the other end portion open, and
a first parasitic element which has one end portion connected to the antenna ground portion and the other end portion open, and operates upon electrically coupling to the first feed element, and
the second antenna unit comprises
a second feed point disposed away from the first feed point at a position near the side of the antenna ground portion,
a second feed element having an intermediate portion bent at least once, one end portion connected to the second feed point, and the other end portion open, and
a second parasitic element which has one end portion connected to the antenna ground portion and the other end portion open, operates upon electrically coupling to the second feed element, and also operates upon electrically coupling to the first parasitic element.

2. The device of claim 1, wherein a distance between a ground position of the first parasitic element and a ground position of the second parasitic element is set to substantially not more than 1/20 a wavelength corresponding to the frequency band.

3. The device of claim 1, wherein a length from a distal end of the first parasitic element to a distal end of the second parasitic element through a side of the antenna ground portion is set to substantially ½ a wavelength corresponding to the frequency band.

4. The device of claim 1, wherein at least one of the first feed element and the second feed element is formed into a T-shape.

5. The device of claim 1, wherein at least one of the first antenna unit and the second antenna unit further comprises one of third parasitic element and a fourth parasitic element which operates upon current-coupling to one of the first feed element and the second feed element at a position opposite to one of the first parasitic element and the second parasitic element through one of the first feed element and the second feed element.

6. The device of claim 1, wherein a length from one of the first feed point and the second feed point to the ground element through a side of the antenna ground portion is set to substantially ¼ a wavelength corresponding to the frequency band.

7. An electronic apparatus comprising:
a ground portion; and
an antenna device;
the antenna device comprises
an antenna ground portion disposed substantially parallel to a ground portion of an electronic apparatus and connected to the ground portion via a ground element, and
a first antenna unit and a second antenna unit which are disposed close to each other within a predetermined distance along a side of the antenna ground portion and for which substantially equal frequency bands for transmission or reception are set,
the first antenna unit comprises
a first feed point disposed close to the side of the antenna ground portion,
a first feed element having an intermediate portion bent at least once, one end portion connected to the first feed point, and the other end portion open, and
a first parasitic element which has one end portion connected to the antenna ground portion and the other end portion open, and operates upon electrically coupling to the first feed element, and
the second antenna unit comprises
a second feed point disposed away from the first feed point at a position near the side of the antenna ground portion,
a second feed element having an intermediate portion bent at least once, one end portion connected to the second feed point, and the other end portion open, and
a second parasitic element which has one end portion connected to the antenna ground portion and the other end portion open, operates upon electrically coupling to the second feed element, and also operates upon electrically coupling to the first parasitic element.

8. The apparatus of claim 7, wherein a distance between a ground position of the first parasitic element and a ground position of the second parasitic element is set to substantially not more than 1/20 a wavelength corresponding to the frequency band.

9. The apparatus of claim 7, wherein a length from a distal end of the first parasitic element to a distal end of the second parasitic element through a side of the antenna ground portion is set to substantially ½ a wavelength corresponding to the frequency band.

10. The apparatus of claim 7, wherein at least one of the first feed element and the second feed element is formed into a T-shape.

11. The apparatus of claim 7, wherein at least one of the first antenna unit and the second antenna unit further comprises one of third parasitic element and a fourth parasitic element which operates upon current-coupling to one of the first feed element and the second feed element at a position opposite to one of the first parasitic element and the second parasitic element through one of the first feed element and the second feed element.

12. The apparatus of claim 7, wherein a length from one of the first feed point and the second feed point to the ground element through a side of the antenna ground portion is set to substantially ¼ a wavelength corresponding to the frequency band.
